(19) United States
(12) Patent Application Publication
(10) Pub. No.: US 2005/0248453 A1
(43) Pub. Date: Nov. 10, 2005

(54) Multiple deterrent, emergency response and localization system and method

(76) Inventor: Cary E. Fechter, Charleston, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/125,998

(22) Filed: May 10, 2005

Related U.S. Application Data
(60) Provisional application No. 60/569,738, filed on May 10, 2004.

(51) Int. Cl. G08B 1/08

(52) U.S. Cl. 340/539.15; 340/573.1

(57) ABSTRACT

A method of locating a distressed individual using a pre-programmed, immediate response alarm device includes the steps of: (a) activating a pre-programmed response alarm device; (b) automatically capturing a digital photograph with the pre-programmed response alarm device; (c) automatically initiating a cellular alarm signal using a primary transmitter of the pre-programmed response alarm device; and (d) automatically transmitting the digital photograph and the cellular alarm signal to a cellular tower. A pre-programmed response alarm device and emergency system are also included herein.

### REFERENCE TO DISCLOSURE DOCUMENT

Benefit is claimed under 35 USC 119(e) of provisional U.S. patent application No. 60/569,738, which was filed in the US Patent & Trademark Office on May 10, 2005.

### BACKGROUND OF THE INVENTION

1. Technical Field

The present device relates generally to a pre-programmed, immediate response camera alarm device and emergency system for locating victims and deterring predators, and a method of immediately locating a victim using the device and system.

2. Background Information

Nothing strikes greater fear into the heart of a parent than hearing that his or her child has been kidnapped. Despite fine programs like the “Amber Alert”, predators are still able to capture and sometimes harm and/or kill children and adults. The pre-programmed, immediate response alarm device and system of the present invention help parents and police to locate and recover victims, hopefully before harm should befall them. Also, the visible and concealed aspects of this device and system will deter many predators from even considering such crimes.

### BRIEF SUMMARY OF THE INVENTION

The present invention includes a pre-programmed, immediate response alarm system comprising a primary camera device with an alarm system, and a preferred secondary receiver/transmitter. The invention also includes a method of locating the distressed individual, which includes the steps of:
(a) activating a pre-programmed response alarm device;
(b) automatically capturing a digital photograph with the pre-programmed response alarm device;
(c) automatically initiating a cellular alarm signal using a primary transmitter of the pre-programmed response alarm device; and
(d) automatically transmitting the digital photograph and the cellular alarm signal to a cellular tower. Preferably the method also includes the steps of:
(e) transmitting the alarm signal and the digital photograph from the cellular tower to a security center via a cellular network;
(f) determining a location of the distressed individual from the alarm signal at the security center; and
(g) notifying a locating authority in the location.
   Alternatively, the security center may notify the appropriate law enforcement agency in the case of a non-emergency situations, such as fraud, vandalism, etc.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a pictorial diagram depicting a general overview of a camera alarm system for a child according to the present invention;

FIG. 2 is a pictorial diagram showing a general overview of a leisure camera alarm system for a child according to the present invention;

FIG. 3 is a pictorial diagram showing a general overview of an emergency camera alarm system for an adult user according to the present invention;

FIG. 4 is a pictorial diagram showing a general overview of an emergency camera alarm system for a senior citizen user according to the present invention;

FIG. 5 is a pictorial diagram showing a general overview of a fraud camera alarm system for a senior citizen user according to the present invention;

FIG. 6A is an exploded, perspective view of a first embodiment of a camera alarm device for a child user according to the present invention;

FIG. 6B is a front elevational view of the camera alarm device for a child user according to FIG. 6A;

FIG. 6C is a side elevational view of the camera alarm device for a child user according to FIG. 6A;

FIG. 7A shows a perspective view of a second embodiment of a camera alarm device for a child user according to the present invention;

FIG. 7B is a front elevational view of the camera alarm device for a child user according to FIG. 7A;

FIG. 7C is a side elevational view of the camera alarm device for a child user according to FIG. 7A;

FIG. 8A is front elevational view of a secondary receiver/transmitter of a camera alarm device according to the present invention;

FIG. 8B is a side elevational view of the secondary receiver/transmitter of a camera alarm device according to FIG. 8A;

FIG. 8C is a cross sectional view of the secondary receiver/transmitter of FIG. 8B, taken along line 1-1;

FIG. 9A is a front elevational view of an alternate embodiment of a secondary receiver/transmitter of a camera alarm device according to the present invention;

FIG. 9B is a side elevational view of the secondary receiver/transmitter of a camera alarm device according to FIG. 9A;

FIG. 9C is a cross sectional view of the secondary receiver/transmitter of FIG. 9B, taken along line 2-2;

FIG. 10 is a first pictorial diagram of a child carrying an alarm device according to the present invention, showing places where a secondary receiver/transmitter may be hidden;

FIG. 11 is a second pictorial diagram of a child carrying a hidden alarm device according to the present invention, showing places where a secondary receiver/ transmitter may be hidden;

FIG. 12 is a perspective view of an alternate embodiment of a camera alarm device for a child according to the present invention;

FIG. 13 is a perspective view of a camera alarm device for an adult user according to the present invention; and

FIG. 14 is a perspective view of a camera alarm device for a senior citizen user according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

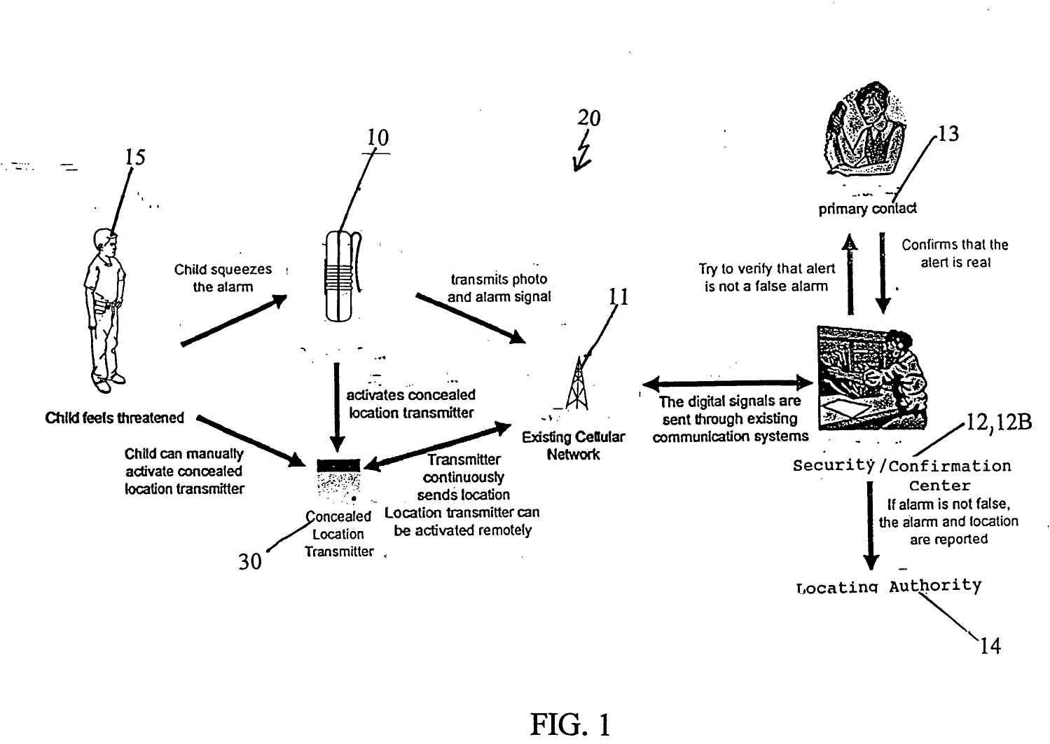

Referring to FIG. 1, a pre-programmed emergency camera alarm system 20 for use by a child 15 provides a means by which a locating authority 14, such as police or other emergency personnel, may locate and assist or retrieve a missing/abducted child 15 or other distressed individual using a camera alarm device 10. The multiple deterrent, pre-programmed emergency system 20 comprises the camera alarm device 10, a concealable, secondary receiver/transmitter 30, an established cellular network 11, and means for connection with a security center 12, a home contact 13, and a locating authority 14 to interact with the alarm system 20.

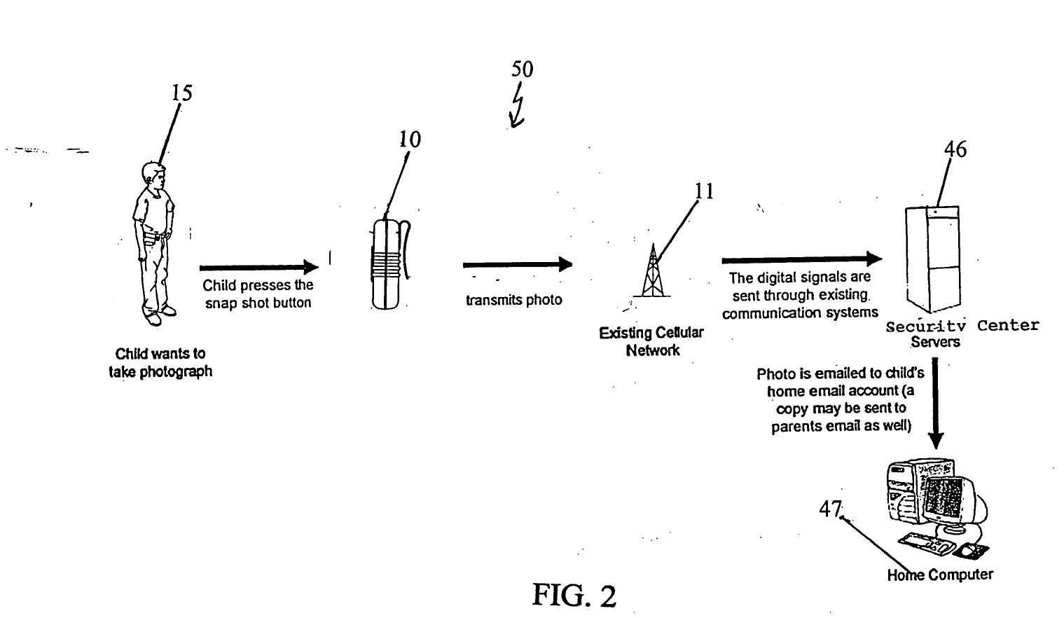

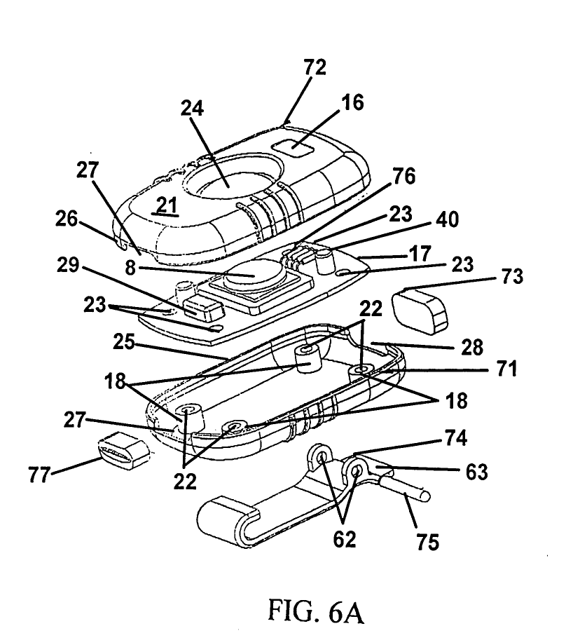

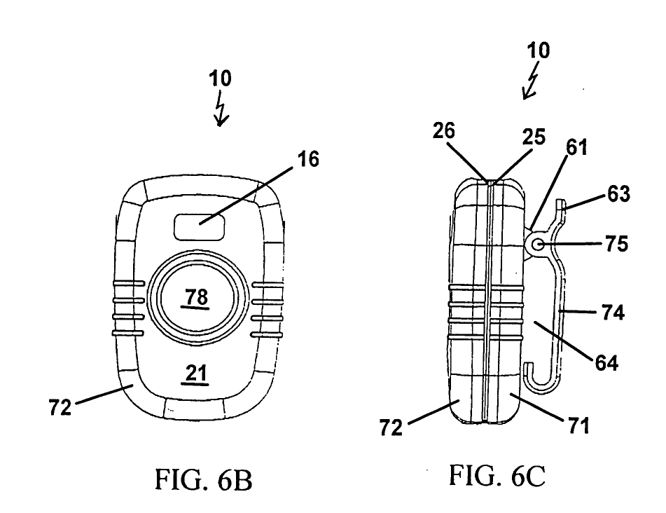

Referring to FIGS. 1 and 2, the camera alarm device 10 functions as both a conventional digital camera and as a distress alarm trigger. Normally, the child user 15 wears the camera alarm device 10, for example, on a string around the neck. The camera alarm device 10 includes a function so that it can also be used conventionally as a digital camera. This leisure encourages older children to bring the device 10 with him or her when he/she leaves the house instead of thinking of it as a irritant and himself/herself as a victim of a neurotic parent. The camera alarm device 10 includes a snap shot button 73, which is shown in FIG. 6A. If the child 15 wishes to take a photograph, the child aims the lens 78 at the desired subject of the photograph and presses the snap shot button 73. In a threatening situation, however, the camera alarm device 10 has a second function for use as a pre-set, immediate alarm system. When threatened, the child 15 simply squeezes the camera alarm device 10, which activates a primary transmitter 40.

Once the cellular signal is initiated, an optional sounding device in the camera alarm system is simultaneously activated. The sounding device preferably emits a sound that is greater than about 100 decibels, so it calls attention to the area. In a children's version of the emergency system 20, the secondary concealed receiver/transmitter 30 is also important because it will silently continue to transmit location data even if the assailant locates and destroys the primary camera device 10. Importantly, the concealed receiver/transmitter 30 can be activated manually and independently of the primary camera device 10. The secondary receiver/transmitter 30 can be physically independent of the camera, and does not require that the camera alarm device be operable in order to operate.

Referring to FIGS. 6A-C, the camera alarm device 10 employs digital camera technology, including a printed circuit board (PCB) 76, and a charger/data input module 77. The charger/data input module 77 is adapted for mating with a conventional digital camera charger to recharge at least one rechargeable battery 79. In a preferred embodiment, the battery 79 is a nickel-cadmium (NiCad) battery. Alternatively, the battery 79 is one or more 9 or 12 volt batteries. Optionally, the camera alarm device 10 includes a solar panel as an additional power source. The charger/data input module 77 is also adapted for mating with a corresponding computer port for uploading software or image files (e.g., .jpg files) onto the camera alarm device 10 and downloading files (such as .jpg files) onto a computer's hard drive, a CD-R, a CD-RW, a floppy disk, etc.

Continuing with FIGS. 6A-C, the printed circuit board (PCB) 76 and the lens 78 are mounted on an interior plate 17, which is surrounded and protected by rear and front device covers 71, 72. The covers 71, 72 are preferably similarly sized, generally convex, and generally rectangular in shape. The device covers 71, 72 are made from a flexible, resilient, inexpensive material, such as a rubber or rubber-type material. To retain the interior plate 17 in place between the device covers 71, 72, a number of rear protrusions 18 project from a back wall 19 of the rear cover 71 and a number of similarly sized, corresponding front protrusions (not shown) project from a front wall 21 of the front cover 72. Preferably, the rear and front protrusions are generally cylindrical in shape. A generally circular, rear screw hole 22 extends through the longitudinal center of each rear protrusion 18 and continues through the rear wall 19. Likewise, a similarly sized, corresponding front screw hole (not shown) extends through the longitudinal center of each front protrusion (not shown); however, it does not extend through the front wall 21 of the front cover 72. Screws (not shown) extending through the rear screw holes 22, plate screw holes 23 in the interior plate 17, and the front screw holes (not shown) secure the covers 71, 72 to the interior plate 17 and hold the covers 71, 72 together along front and rear edges 25 and 26 of the covers 71, 72.

In an alternate embodiment, the covers are welded together. Based on current testing, it has been found that it is best for the device covers to be welded together to form a single unit in order to meet moisture and durability standards. The camera alarm device 10 is preferably disposable.

Continuing with FIGS. 6A-C, the lens 78 projects into a lens aperture 24 in the front cover 72. The charger/data input module 77 is visible and accessible through charger/data input module cutouts 27 at the lower end of the camera alarm device 10, while the snap shot button 73 is visible and accessible through button cutouts 28 at the upper end of the camera alarm device 10. For a young woman user, the camera alarm device 10 further comprises an automatic flash 16, which is important for unaccompanied travel from work or school in a dark parking garage, poorly lit street, etc.

A clip 74 for securing the camera alarm device 10 to a belt, backpack, purse, pocket, etc., is mounted to the back cover 71 with a pivot pin 75. The pivot pin 75 extends through generally circular first pin apertures 62 in the clip 74, and similarly sized, generally circular second pin apertures (not shown) in the back cover protrusions 61. In a preferred embodiment of the camera alarm device 10, the clip 74 is spring-loaded. In order to removably attach the camera alarm device 10 to an article of clothing or other item, the child 15 pushes an upper end 63 of the clip 74 towards the back cover 72 and inserts the item, for example, a belt, in an opening 64 between the back cover 71 and the clip 74. Then the child 15 releases pressure on the upper end 63, so that the camera alarm device 10 snaps onto the item (e.g., belt).

As illustrated in FIG. 6A, an emergency button 29 attached to the interior plate 17 is hidden within the camera alarm device 10. In a preferred embodiment, a double squeeze of an approximately ⅛ inch depressed emergency button concurrently initiates the taking of a digital photograph and activates the primary transmitter 40. Both the double squeeze activity and the depressed nature of the emergency button 29 will prevent accidental activation. Thus, if the button is accidentally depressed or the camera device is accidentally squeezed, the emergency function of the camera alarm device is not initiated. The primary transmitter 40 automatically transmits the digital photograph to the confirmation center and continuously transmits an alarm signal. The concealed secondary receiver/transmitter 30 is designed with an efficient battery system so that it will also transmit a signal for an extended length of time. The hidden secondary receiver/transmitter 30 is also preferably automatically activated, and is difficult for an assailant to find and destroy or discard.

The confirmation center 12b is preferably a team of individuals that must confirm a distress situation prior to relaying information to a law enforcement agency (see FIG. 1). Law enforcement generally finds confirmation to be a necessary step, since children and elderly persons in particular are more likely to initiate false alarms. Upon confirmation, the security center 12 relays data regarding the victim, and hopefully the predator, directly to dispatchers. The security center 12 also has the responsibility to forward pertinent data to the most appropriate law enforcement agency 59 or division in non-emergency situations, such as fraud, vandalism, minor car accidents, etc.

The FCC (Federal Communications Commission) has dictated that Multimedia Messaging Service (MMS) signaling be capable of triangulation and location. The triangulation process requires more than one receiving tower or device. In general, law enforcement agencies have been equipped with triangulation receivers. The camera alarm device 10 is particularly effective in well-populated areas with their higher signal tower concentrations. The same camera alarm system 20 can be used in rural areas using GPS (Global Positioning System) signals; however, the shortcomings of a GPS system, such as inability to penetrate cloud cover or building walls, apply here as well. Nonetheless, many individuals, such as individual hunters or backpackers or young women in rural areas, would likely prefer a more costly GPS-based emergency system 20 with its faults to no protection at all.

The camera alarm device 10 uses a cellular alarm signal to locate the distressed child 15 or adult by triangulation. Both are preferably transmitted by Multimedia Messaging Service (MMS) via a Wireless Local Area Network (WLAN) utilizing an existing cellular network (i.e., a mobile telephone network) that allows information to be sent and received between mobile devices using Wireless Application Protocol (WAP) as a bearer technology in conjunction with a high-speed transmission technology. Multimedia Messaging Service (MMS) allows users to send and receive multimedia information, such as digital photographs, animated pictures, audio clips, video clips, and text via a cellular network. The cellular network operates over dedicated radio frequencies for providing wireless communication with cellular devices, such as cellular telephones, and, as described herein, the personal camera alarm device 10.

MMS (Multimedia Messaging Service) is generally less expensive than GPS (Global Positioning Satellite) and importantly allows greater penetration of building structures, so that it is difficult to hide a victim/distressed person from the emergency system 20. The camera alarm device 10 and system 20 assist in rapidly locating the victim/distressed person. Speed and immediacy translate into savings for both the provider and the user in the future, in addition to the obvious benefits.

MMS is also universal, which allows the camera alarm device 10 and system 20 the capability of deterring crime in the United States, and the rest of the world. The camera alarm device 10 and system 20 act as a crime deterrent because once potential assailants recognize that this device 10/system 20 is in use, and includes a concealed element (the secondary receiver/transmitter 30), they will hesitate to carry out crimes as readily. The inexpensive nature of this camera alarm system allows wide use and greater vigilance. Many users will begin to photograph crimes in progress as they witness such crimes. Secondly, the camera alarm device will reduce criminal activity by supplying evidence of such crimes for prosecution of the perpetrators.

The camera alarm device 10 requires an operating system in order to digitally capture images, process images, transmit images, and transmit the alarm signal. MMS does this and also allows unlimited text size. It therefore allows standard and even professional grade photograph transmission. By enhancing the “leisure mode” herein, use of the camera alarm device 10 is made more pleasurable. The more important function of the camera alarm system, protection and deterrence of abduction and crime, is not obvious on viewing the camera alarm device 10/system 20.

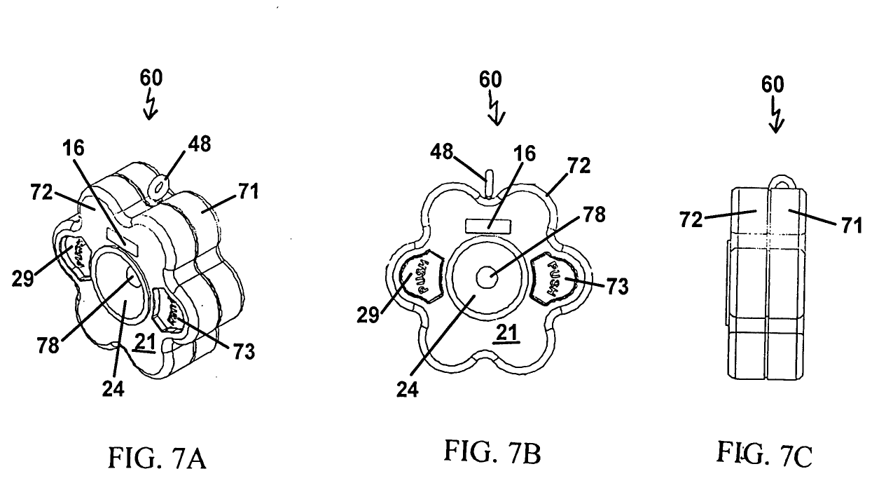

Referring to FIGS. 7A-C, an alternate embodiment 60 of the camera alarm device is for a child 15 or adult user to carry and use. This camera alarm device embodiment 60 comprises a rear cover 71, a front cover 72, and an interior plate 17, to which a PCB 6 and a lens 78 are attached. In one embodiment, the rear cover 71, front cover 72, and interior plate 17 are secured together by rear screw holes 22, front screw holes (not shown), plate screw holes 23, and screws (not shown), as described hereinabove. In an alternate embodiment, the rear cover 71, front cover 72, and interior plate 17 are welded together to protect from moisture. The lens 78 of the camera alarm device 60 is visible through the lens aperture 24.

In the embodiment shown in FIGS. 7A-C, the lens 78 is recessed from the front wall 21 of the front cover 2. The recessed lens 78 decreases the chance of the child 15 or other user touching and smudging or otherwise damaging the lens 78. The snap shot button 73 and the emergency button 29 are both located in or on the front face 21. In a threatening situation, the child 15 or other user simply depresses the emergency button 29 on the camera alarm device 60 twice in order to reduce the likelihood of inadvertent activation. The snap shot and emergency buttons 73, 29 may be substantially similar in appearance to one another, as shown in FIGS. 7A-B, so that they do not attract an attacker's attention.

The front, snap-on cover may come in a variety of shapes that appeal to children, such as the flower-like shape depicted in FIGS. 7A-B. The camera alarm device 60 includes an eye 48 attached to the camera front or back cover 71, 72. The eye 48 receives a strap or chain so that the camera alarm device 60 may be worn around the child's neck. The camera alarm device 10, 60 may have a more complicated design and additional features for use by an older child 15.

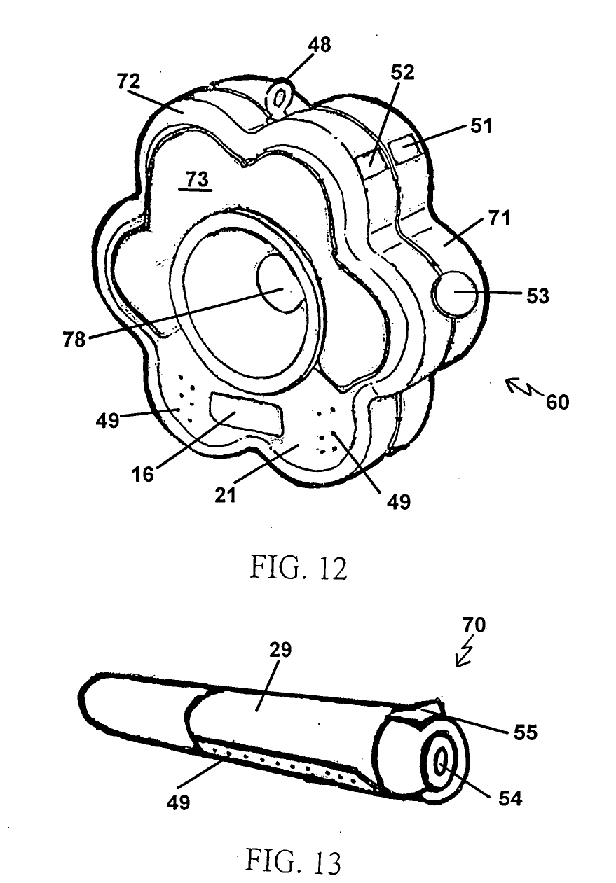

Referring to FIG. 12, pushing a leisure button 51 causes the camera alarm device 10, 60 to function solely as a digital camera. Pushing the “911” function button 52 prepares the camera alarm device 10, 60 for transmitting the alarm signal. When the leisure button 51 is depressed, pushing the snap shot button 73 only captures digital photographs. However, when the 911 function button 52 is depressed, depressing the snap shot button 73 captures a digital photograph of whatever the camera is pointed at, activates the primary transmitter 40, and activates the optional secondary receiver/transmitter 30. Thus, if the child user 15 feels threatened, he or she presses the 911 function button 52, aims the lens 78 at the assailant, if possible, and presses the snap shot button 73. The snap shot button 73 may be recessed from the front wall 21. An audible alarm, which notifies the child that he or she has pushed the emergency button 29, and alerts passers by, preferably sounds through speakers 49 upon depression of the emergency button 29. The camera alarm device 10, 60 may also include a pick-up notification button 53.

In preferred embodiments, the camera alarm devices 10, 60 are made from durable, injection molded plastic. However, some areas of the camera alarm devices 10, 60 may be metalized. Any batteries in the device 10, 60 are separated from the printed circuit board in order to avoid corrosion of the printed circuit board and ensure durability. The camera alarm devices 10, 60 optionally include an automatic flash 16, which activates a flash bulb in the camera alarm device 10, 60.

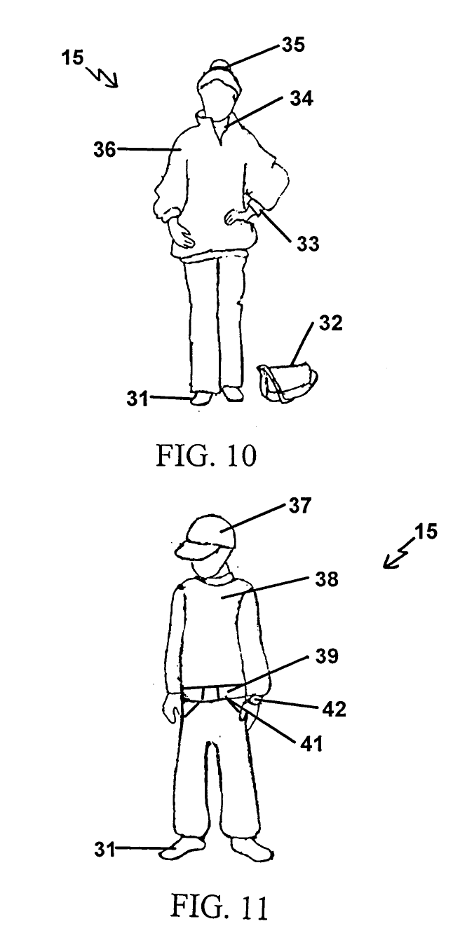

A concealable, secondary receiver/transmitter 30 is preferably included in a camera alarm system 20 of the present invention. The secondary receiver/transmitter 30 is small and easily hidden in a child user's clothing. FIGS. 10 and 11 show possible alternate locations for concealment of the secondary receiver/transmitter 30. The secondary receiver/transmitter 30 may be attached to, inserted in, or otherwise mounted on the user's shoe 31, purse 32, bracelet 33, necklace 34, burette 35, upper arm 36, hat 37, dog tag 38, belt 39, wallet 41, or watch 42, for example. The secondary receiver/transmitter 30 serves as a backup to the primary transmitter 40 contained within the camera alarm device 10. Although an attacker may remove the camera alarm device 10 from the child 15 or other user, it is less likely that the attacker will find and remove the concealed secondary receiver/transmitter 30 from the child 15 or other user.

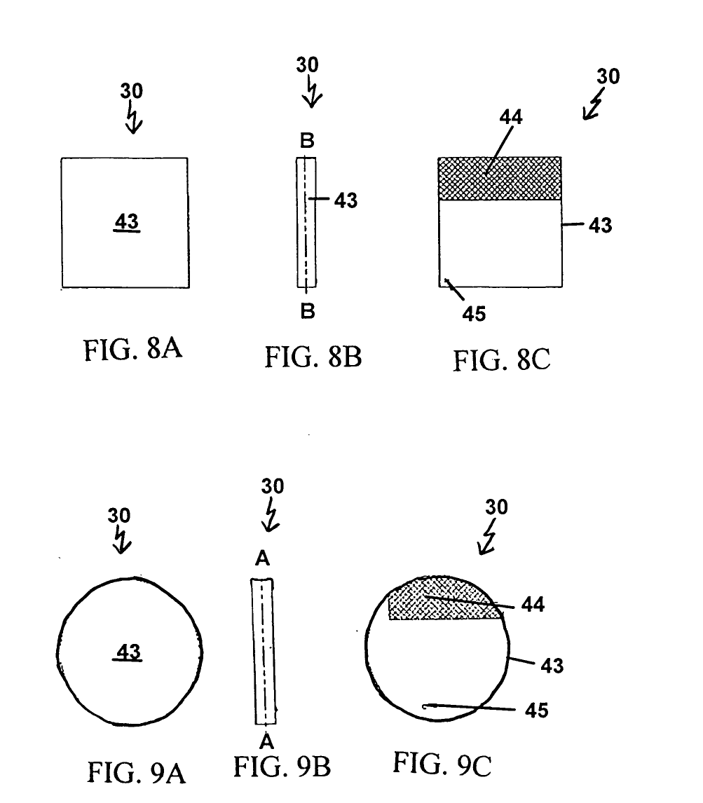

FIGS. 8A-C and 9A-C illustrate two alternate embodiments of the secondary receiver/transmitter 30. The secondary receiver/transmitter 30 is comprised of a transmitter base 43, a power source 44, and an antenna 45. Squeezing the camera alarm device 10 and depressing the emergency button 29 optionally automatically activates the secondary receiver/transmitter 30. This is advantageous in that a panicked child 15 or other user need not remember more than the double button push for activating the camera alarm device 10. The secondary receiver/transmitter 30 is automatically and instantly activated by the camera alarm device 10. Alternatively, the security center 12 and/or the locating authority 14 may remotely activate the secondary receiver/transmitter 30. Upon activation, the secondary receiver/transmitter 30 transmits data signals to the security center 12 and/or the locating authority 14 via Multimedia Messaging Service (MMS), cellular phone-like technology. The data signals allow the security center 12 and/or the locating authority 14 to locate the distressed child 15 by user-specific coding for that child, and even distinguish between the primary camera alarm device and the concealed secondary receiver/transmitter. Location is by triangulation. The concealed secondary receiver/transmitter 30 preferably does not emit an audible frequency, thus adding to its deterrent potential. Only in the example of activation of a high decibel piezo sounding device does the audible nature of the emergency device 10, 60 become obvious to the assailant and bystanders.

Turning back to FIGS. 1 and 6A-C, if the child 15 or other user feels threatened, he or she squeezes the camera alarm device 10, which depresses the emergency button 29. The camera alarm device 10 then automatically and immediately transmits the digital photo and the alarm signal to the nearest cellular tower of an existing cellular network 11. Concurrently, the camera alarm device 10 activates the secondary receiver/transmitter 30. The secondary receiver/transmitter 30 continuously emits data signals to the nearest cellular tower of an existing cellular network 11 and, with proper maintenance, will preferably transmit signals for at least 48 hours.

Alternatively, if the child 15 feels threatened, he or she may manually activate the secondary receiver/transmitter 30 in the case where the child 15 does not have convenient access to, or forgets about, the camera alarm device 10. This may be necessary, for example, if an attacker snatches the camera alarm device 10 from the child 15. A similar squeeze mechanism exists for the concealed secondary receiver/transmitter 30. Again, a double triggering is preferably required to initiate an alarm from the secondary receiver/ transmitter. The transmitter casing is sensitive to manual activation.

The owner of the camera alarm device 10 (such as a parent of the child 15), the security center 12, or the locating authority 14 may also remotely activate the secondary receiver/transmitter 30. This may be necessary, for example, if upon attack, the child 15 is too fearful or does not act quickly enough to squeeze the camera alarm device 10 or manually activate the secondary receiver/transmitter 30.

The digital photograph and the alarm signal from the camera alarm device 10, 60, if initiated, and the continuous data signals from the secondary receiver/transmitter 30, if it has been activated, are transmitted via an existing cellular network 11 to the security center 12. The security center 12 then contacts a primary contact 13 to ascertain whether the alarm signal and/or data signals are valid/real or false/accidental. If the parent or other caregiver verifies that the alarm signal and/or data signals are or may possibly be valid/real, the security center 12 notifies the locating authority 14 of the child's situation and location.

Referring to FIGS. 2, 6A-C, and 7A-C, if the child 15 or other user depresses the snap shot button 73 on the camera alarm device 10, 60 to take a regular photograph, the child 15 initiates a photograph processing system 50. Upon depression of the snap shot button 73, the camera alarm device 10, 60 captures, processes, and transmits the digital photograph to the nearest cellular tower of an existing cellular network 11. The digital photograph is then transmitted via the cellular network 11 and through a security center server 46 to an e-mail account designated earlier by the system owner. The e-mail account may be the child's e-mail account or a parent/guardian's e-mail account. The child 15 or system owner can then retrieve the digital photograph from the e-mail account on a home computer 47.

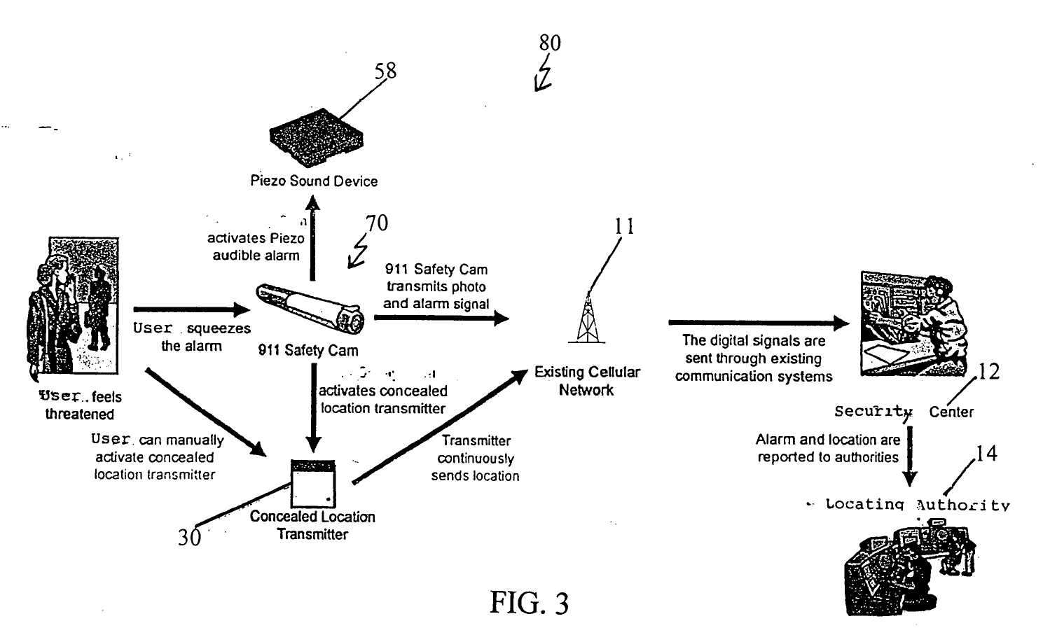

Referring to FIG. 13, an alternate embodiment 70 of a camera alarm device is particularly useful for a young female who is at high risk of assault. FIG. 3 shows a corresponding camera alarm system 80 for an adult user. The camera alarm device 70 generally has the shape of a pen or a flashlight, and is preferably attachable to a key chain. The device 70 importantly includes an automatic triggered piezo alarm 58, which includes a local frequency receiver and emits a wail, preferably a 108 decibel siren, which the user can manually activate or deactivate. The emergency system 80 most preferably has a ten to fifteen second delay built-in in case of inadvertent activation or a false alarm. In its preferred embodiment, the small camera alarm device 70 is comprised of a wide angle lens 54, speakers 49 for projecting the audible alarm, an emergency button 29, and a multi-flash mechanism 55, as shown in FIG. 13. The multi-flash mechanism 55 is desirable on the adult camera alarm device 70 since adults are more susceptible to attack at night, when it is dark. The emergency system 80 is designed to function solely for emergency purposes. In order to facilitate rapid response, as in the case of a sexual assault, no confirmation is required from relatives before the dispatcher contacts law enforcement or other agents for retrieval of the victim. The agents will receive personal data regarding the victim, a superimposed grid map of the location, and hopefully also a photograph of the assailant, if the victim had time to take one.

Continuing with FIGS. 3 and 13, if the user feels threatened, he or she squeezes the adult camera alarm device 70, which depresses the emergency button 29. The camera alarm device 70 then automatically and immediately transmits the digital photo and the alarm signal to the nearest cellular tower of an existing cellular network 11. Concurrently, the adult camera alarm device 70 activates the secondary receiver/transmitter 30 and initiates the piezo sound device 58 (see FIG. 3). The secondary receiver/transmitter 30 continuously emits data signals to the nearest cellular tower of an existing cellular network 11 and, if properly maintained and charged, will transmit a continuous signal for at least 48 hours. The piezo sound device 58 typically screams for four to five minutes upon activation. The piezo sound device 58 emits the audible alarm through the speaker 49.

Alternatively, if the adult user feels threatened but does not have convenient access to the camera alarm device 10, or panics and forgets about it, she or he may manually activate the secondary receiver/transmitter 30. Remote secondary receiver/transmitter activation is as discussed hereinabove. This may be necessary, for example, if an attacker snatches the camera alarm device 70 from the adult. In this camera alarm system 80, the security center 12 or the locating authority 14 may also remotely activate the secondary receiver/transmitter 30. This may be necessary, for example, if the user being attacked is too fearful or does not act quickly enough to squeeze the camera alarm device 70 or manually activate the secondary receiver/transmitter 30. The secondary receiver/transmitter 30 has a unique identification code much like cellular telephones and can be called with the message to begin the MMS signaling, which allows localization, mapping, etc.

This technology can be added as a pre-programmed package for current cellular telephones using existing frequencies in order to allow cellular users immediate emergency signaling. The emergency signals will be received by the confirmation center. This will couple personal data and location data for the user in distress, including mapping. Mapping requires the super-imposition of a triangulated point onto a street map. Using MMS signal technology allows identification of the location of the distressed person. The emergency system 80 is frequently immediately accurate to within approximately a city block, and is most preferably accurate within a few meters with continued signaling.

In the emergency system 80 described in FIG. 3, the digital photograph and the alarm signal from the adult camera alarm device 70, if initiated, and the continuous data signals from the secondary receiver/transmitter 30, if initiated, are transmitted via the existing cellular network 11 to the security center 12. Then the security center 12 notifies the locating authority 14 of the adult user's situation and location.

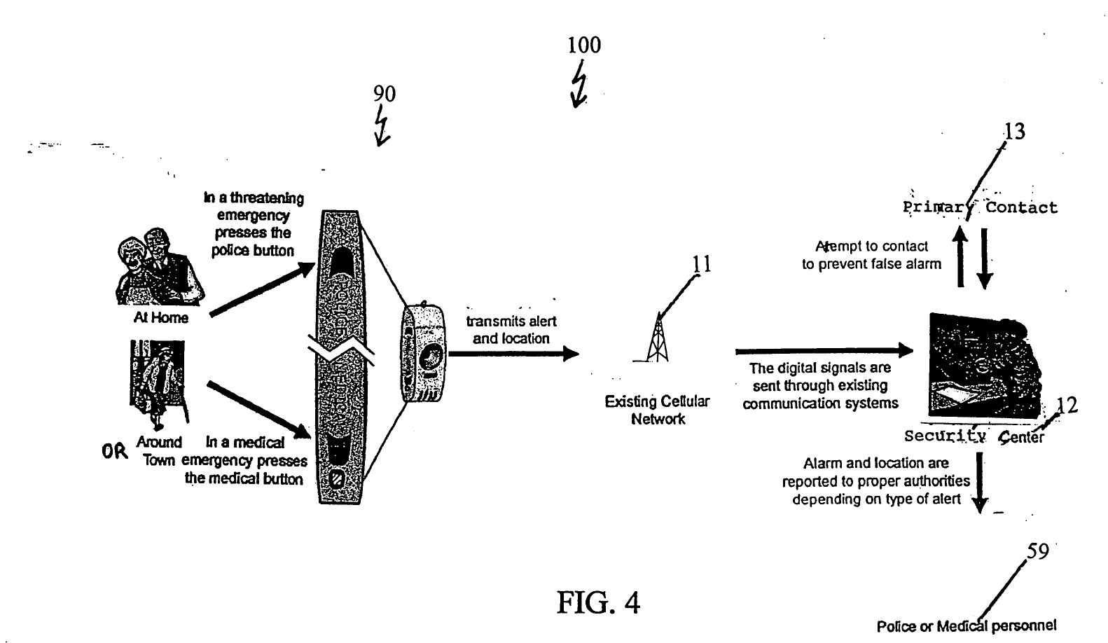

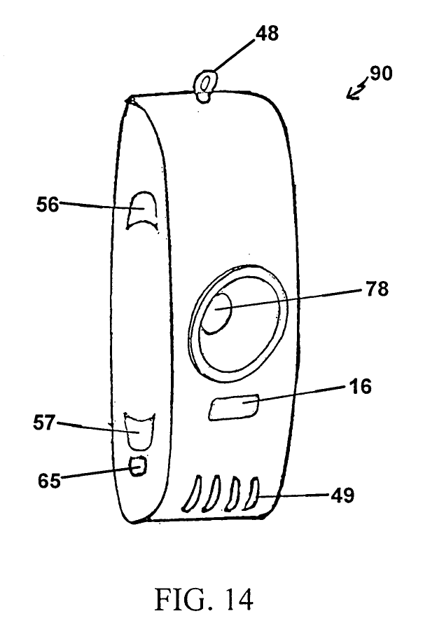

Referring next to FIGS. 4 and 14, an alternate embodiment of a camera alarm device 90 for senior citizens (or others) is easily operated and preferably relatively large in size. FIG. 4 shows a corresponding emergency system 100 for the senior citizen user. The senior citizen camera alarm device 90 comprises a recessed lens 78, a snap shot button 73 (not shown), a police button 56, a medical emergency button 57, and an eye 48 for accommodating a string. The senior's camera alarm device 90 includes speakers 49 for sounding an audible alarm. The senior's camera alarm device 90 includes an optional automatic flash 16 and a power port 65 for recharging the device.

Continuing with FIG. 4, if the senior citizen feels threatened and requires police assistance, she or he depresses the police button 56 on the device 90 (see FIG. 14). If the senior citizen is experiencing a medical problem, such as a heart attack, and requires emergency medical assistance, he or she pushes the medical emergency button 57 on the device 90. Both buttons 56, 57 initiate the emergency alarm system 100 in which the senior's camera alarm device 90 automatically and immediately transmits an alarm signal to the nearest cellular tower of an existing cellular network 11. Likewise, in this emergency system 100, the signal is transmitted via the existing cellular network 11 to the security center 12. The security center 12 then contacts a primary contact 13, such as a relative or a nursing home front desk, to ascertain whether the alarm signal and/or data signals are valid/real or false/accidental. If the primary contact 13 verifies that the alarm signal and/or data signals are or may possibly be valid/real, or if the primary contact 13 cannot be reached, the security center 12 notifies police or emergency personnel, depending upon the type of emergency, of the senior citizen's situation and location.

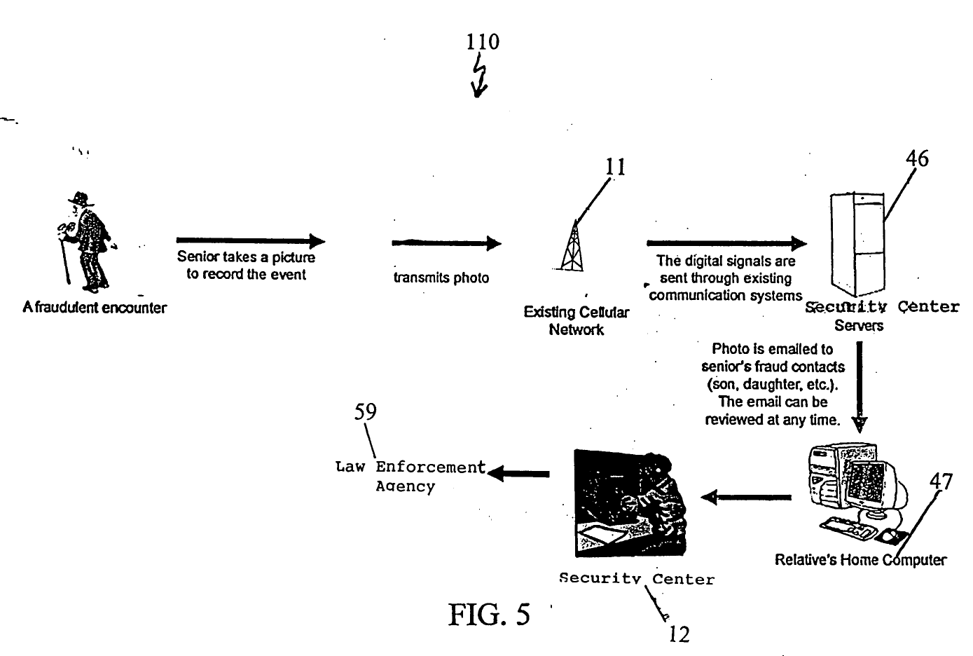

Referring to FIG. 5, if the senior citizen suspects that a crime is about to be committed, he or she depresses the snap shot button 73 on the camera alarm device 90 to take a photograph and record the fraudulent encounter and initiate a fraud photograph processing system 110. Upon depression of the snap shot button 73, the camera alarm device 90 captures, processes, and transmits the digital photograph to the nearest cellular tower of an existing cellular network 11. The digital photograph is then transmitted via the cellular network 11 and through a security center server 46 to an e-mail account designated by the system owner. The e-mail account may be the senior citizen's e-mail account or an account belonging to a friend or relative, such as a son or a daughter. The senior citizen or his or her friend or relative can then retrieve the digital photograph from the e-mail account on a home computer 47. This can also be done with the other camera alarm devices herein.

The present invention includes a method of locating a distressed user 15 by identifying the assailant and relaying personal information regarding the distressed individual and his or her location to authorities, such as police, campus guards, park security, parents, etc. This method includes the steps of:
(a) activating a camera alarm device 10, 60, 70, 90;
(b) automatically capturing a digital photograph with the camera alarm device 10, 60, 70, 90;
(c) automatically initiating a cellular alarm signal using a primary transmitter 40 of the camera alarm device; and
(d) automatically transmitting the digital photograph and the cellular alarm signal to a cellular tower.

This method preferably further comprises the following steps:
(e) transmitting the alarm signal and the digital photograph from the cellular tower to a security center 12 via a cellular network 11;
(f) determining a location of the distressed individual 15 from the alarm signal at the security center 12; and
(g) notifying a locating authority 14 in the location.
   Alternatively, the security center may notify the appropriate law enforcement agency in the case of a non-emergency situations, such as fraud, vandalism, etc.

Activation of the camera alarm device 10, 60, 70, 90 (step a) preferably comprises the steps of: a) squeezing the camera alarm device 10, 60, 70, 90; and b) depressing an emergency button 20 on the camera alarm device. Preferably, depressing the emergency button 20 also automatically activates the primary transmitter 40 (see step c).

The method of location preferably also includes the step of: automatically activating a concealed secondary receiver/transmitter 30. The secondary receiver/transmitter 30 may alternatively be manually activated by the user, or remotely activated by the security center 12 or locating authority 14. The secondary receiver/transmitter 30 is preferably hidden in the clothing the user is wearing prior to setting out so that it is difficult for an assailant to find. Once it is activated, the secondary receiver/transmitter 30 transmits a signal for an extended length of time in order to facilitate location of the distressed individual.

From the foregoing it can be realized that the described device of the present invention may be easily and conveniently utilized as a camera alarm device and emergency system, and a method of locating a user of the camera alarm device and system. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method of locating a distressed individual using a camera alarm device, the method comprising the steps of:
(a) activating a camera alarm device;
(b) automatically capturing a digital photograph with the camera alarm device;
(c) automatically initiating a cellular alarm signal using a primary transmitter of the camera alarm device; and
(d) automatically transmitting the digital photograph and the cellular alarm signal to a cellular tower.

2. The method of location according to claim 1, further comprising the steps of:
(e) transmitting the alarm signal and the digital photograph from the cellular tower to a security center via a cellular network;
(f) determining a location of the distressed individual from the alarm signal at the security center; and
(g) notifying a locating authority in the location.

3. The method of location according to claim 1, further comprising the step of: automatically activating a concealed secondary receiver/transmitter separate from the camera alarm device.
